(19) United States
(12) Patent Application Publication
(10) Pub. No.: US 2024/0027718 A1
(43) Pub. Date: Jan. 25, 2024

(54) SUPPORTING AND ROUTING DROP LINES FROM AN ALL-DIELECTRIC SELFSUPPORTING (ADSS) FIBER OPTIC TRUNK CABLE

(71) Applicant: OFS Fitel, LLC, Norcross, GA (US)

(72) Inventors: Mark A Boxer, Pinetown, NC (US); John E George, Cumming, GA (US); Howard M Kemp, Brandon, FL (US); Henson P Toland, Atlanta, GA (US)

(73) Assignee: OFS Fitel, LLC, Norcross, GA (US)

(21) Appl. No.: 18/023,841

(22) PCT Filed: Aug. 31, 2021
(86) PCT No.: PCT/US21/48432

§ 371 Date: Feb. 28, 2023

Related U.S. Application Data
(60) Provisional application No. 63/073,201, filed on Sep. 1, 2020.

(51) Int. Cl. G02B 6/44; G02B 6/48

(52) U.S. Cl. CPC G02B 6/4431; G02B 6/483

(57) ABSTRACT

Drop lines are supported and routed from a an ADSS trunk cable to designated users. Each of a number of non-metallic elongated support members has a main passage, and a first slit for enabling the cable to be urged into the passage from outside. Each member also has a number of aligned outer passages, and associated second slits for enabling a drop line to be urged into a given outer passage from outside. A band may be applied about each support member to prevent the cable and the drop lines from escaping the member through the slits. One end of each drop line is connected to the cable fibers inside a closure fixed at one end of a cable span. A drop line exiting an outer passage in a given support member is routed either through an outer passage in a successive member, or away from the cable to a designated user.

### CROSS-REFERENCE TO RELATED APPLICATION

This application claims priority under 35 U.S.C. § 119(e) of U.S. Provisional Patent Application No. 63/073,201 filed Sep. 1, 2020, the entire contents of which are incorporated by reference.

### BACKGROUND OF THE INVENTION

### Field of the Invention

The present invention relates to fiber optic cables, particularly to supporting and routing drop lines from an all-dielectric self-supporting (ADSS) fiber optic trunk cable, and to supporting an ADSS cable from another cable.

### Discussion of the Known Art

ADSS fiber optic cables contain glass fibers often used to distribute Fiber-to-the-Home (FTTH) services including, e.g., Internet, telephony, television, and other data streams. The cables are self-supporting over specified distances when anchored at opposite ends to poles, towers, or other fixed structures. Because the cables contain no metallic components, they do not pose a safety hazard if deployed within strong electric fields such as those produced by high voltage power lines. The fibers in ADSS cables may be routed loosely inside flexible, gel-filled or gel-free buffer tubes (so called “loose tube” cables), or arranged in ribbon configurations. See, e.g., U.S. Pat. No. 9,323,019 (Apr. 26, 2016), and U.S. Pat. No. 10,591,691 (Mar. 17, 2020), all relevant portions of which are incorporated by reference.

FIG. 1 is a cross-sectional profile of a typical loose tube ADSS cable 10 sold by OFS Fitel, LLC under the registered trademark PowerGuide Short Span DT. The cable is intended for light duty, short span, non-custom applications. As seen in the drawing, the cable 10 includes:
A central dielectric strength or tension rod member 12 made of epoxy-fiberglass;
Gel-free buffer tubes 14 stranded about the central rod m ember 12 with a reverse oscillating lay (ROL) twist;
Optical fibers 16 routed inside the buffer tubes 14;
A water swellable yarn 18 or other water blocking material routed with the fibers inside each tube 14;
Dry water blocking materials 20 applied over the tubes 14;
Dielectric strength members 22; and
A medium-density polyethylene (MDPE) outer jacket 24.

For many years, telephone and cable television service providers have lashed both trunk and drop cables to a metallic messenger wire or cable for support. ADSS cables are now preferred for use as trunk lines in new co-op and municipal FTTH installations when such entities had not previously cables in new installations including, e.g., installation speed, less preparation, little or no regular maintenance, and minimal cable anchoring requirements, thereby yielding a greater return on investment. Notwithstanding, because of issues concerning the management of drop lines to individual users from an ADSS trunk cable, some industry consultants still recommend that standard loose tube cables be lashed onto existing trunk cables to serve as drop lines. Such recommendations may be based on common practices in the telephone and cable TV industries, which call for the lashing of telephone and coaxial TV cables onto steel messenger wires whose ends are anchored to poles or other fixed structures. The steel messenger wires are by definition conductive, and thus require additional clearances from other metallic cables in comparison with all-dielectric, non-metallic cables such as ADSS cables. Such lashing can result in significant costs by requiring extensive work to make existing poles ready for the additional lashed cables.

This “make ready” process involves moving cables up and down on a given pole to comply with cable-to-cable and cable-to-ground clearance requirements specified by the National Electric Safety Code (NESC). In some cases, poles may need to be replaced to enable compliance. In one known situation, published in a report by the NRTC, Broadband-Benchmarking-Report-2020, the make-ready cost was $12,000/mile or $2.27/foot. Make-ready costs are typically very much lower with ADSS networks, however.

Until the present invention, there was no known reliable and aesthetically viable method of coupling, supporting and routing user drop lines from an ADSS trunk cable. Industry requirements limit the strain on fibers contained in fiber optic cables to less than 0.2% over the lifetime of the fibers. Lashing drop lines to a trunk cable will increase the overall weight of the attached lines and cable, and their effective diameter with respect to wind or icing. Nevertheless, drop lines ordinarily do contain strength members to control strain. There are two ways to model how the addition of drop cables to an ADSS will affect strain.

(1) The ADSS trunk cable absorbs all the load from all cables.

(2) The trunk cable and drop lines behave as a coupled system, so the additional amount of strain added to the trunk cable by the drop lines is reduced, since the drop cables will also absorb load.

Testing to determine which model governs when drop lines are coupled to a trunk ADSS is also contemplated by the present invention.

Known devices for supporting two or more lines or cables along a given span include (i) Preformed Line Product (PLP) bushings that may hold multiple drop lines inside of a tangent clamp, (ii) rubber bands, (iii) electrical conductor spacing devices, and (iv) AFL Telecommunications tangent clamps combined for two lines. Therefore, a reliable and aesthetically viable solution that enables a number of user drop lines to be supported along a span of an ADSS trunk cable until each drop line is routed away from the cable to a designated user, would be very desirable.

### SUMMARY OF THE INVENTION

According to one aspect of the invention, a system for supporting and routing drop lines from an all-dielectric self-supporting (ADSS) fiber optic trunk cable containing a number of fibers for providing network service to designated users, includes a number of elongated, non-metallic tubular support members each having a main passage in the longitudinal direction of the member, wherein the main passage is sized to receive and contain the trunk cable. A first slit is formed along the length of each member which opens between the circumference of the member and the main passage when the cable is urged sideways through the first slit from outside the member to enter the main passage.

Each support member also has a number of outer passages aligned with the main passage. Each outer passage is sized to receive and contain one or more user drop lines, and has an associated second slit formed along the length of the member opens between the circumference of the member and the outer passage when a given drop line is urged sideways through the second slit from outside the member to enter the outer passage. A drop line exiting an outer passage in a given support member placed along the span of the trunk cable is either routed through an outer passage of a successive member along the cable, or away from the cable to service a designated user.

According to another aspect of the invention, a method of supporting and routing drop lines from an ADSS fiber optic trunk cable containing a number of fibers for providing network service to designated users, includes forming a number of elongated, non-metallic tubular support members each with a main passage in the long direction of the member, sizing the main passage to receive and contain the trunk cable, and providing the main passage with an associated first slit along the length of the member which opens between the circumference of the member and the main passage when the cable is urged sideways through the first slit from outside the member and received in the main passage.

Each support member is also formed with a number of outer passages along the length of the member and aligned with the main passage, wherein each outer passage is sized to receive and contain one or more of the user drop lines and has an associated second slit along the length of the member which opens between the circumference of the member and the outer passage when a given drop line is urged sideways through the second slit from outside the member and received in the outer passage.

A number of the support members are placed at determined intervals along a span of the trunk cable, and the cable and the drop lines are received in the corresponding passages in the support member. Each drop line exiting an outer passage of a given support member along the span of the trunk cable, is either routed through an outer passage of a successive member along the cable, or away from the cable to service a designated user.

In another embodiment of the invention, each non-metallic tubular support member has first and second passages in the long direction of the member, wherein the first passage is sized to receive a metallic or a non-metallic support cable such an as electrical neutral wire, and the second passage is sized to receive a trunk ADSS cable. Additional passages may also be formed for drop lines. In this embodiment, the trunk ADSS cable is supported at points along the span by the separate support cable, effectively reducing both the span length and the sag of the ADSS cable.

In yet another embodiment of the invention, the slits associated with the passages are cut along a wavy or curvilinear line through the walls of the support members so that once received in the passages, additional force is required to displace the cables radially out of the passages through the slits without the use of a bands about the circumference of the members.

For a better understanding of the invention, reference is made to the following description taken in conjunction with the accompanying drawing and the appended claims.

### BRIEF DESCRIPTION OF THE DRAWING FIGURES

In the drawing:

FIG. 1 is a cross-sectional profile of a known ADSS fiber optic cable;

FIG. 2 is a perspective view of a first embodiment of a cable support member according to the invention;

FIG. 3 is a cross-sectional profile of a second embodiment of a cable support member according to the invention;

FIG. 4 shows a span of an ADSS cable with the inventive cable support members placed at intervals along the span, and drop lines supported by the members for routing to designated users; and

FIG. 5 is a cross-sectional profile of a third embodiment of a cable support member according to the invention.

### DETAILED DESCRIPTION OF THE INVENTION

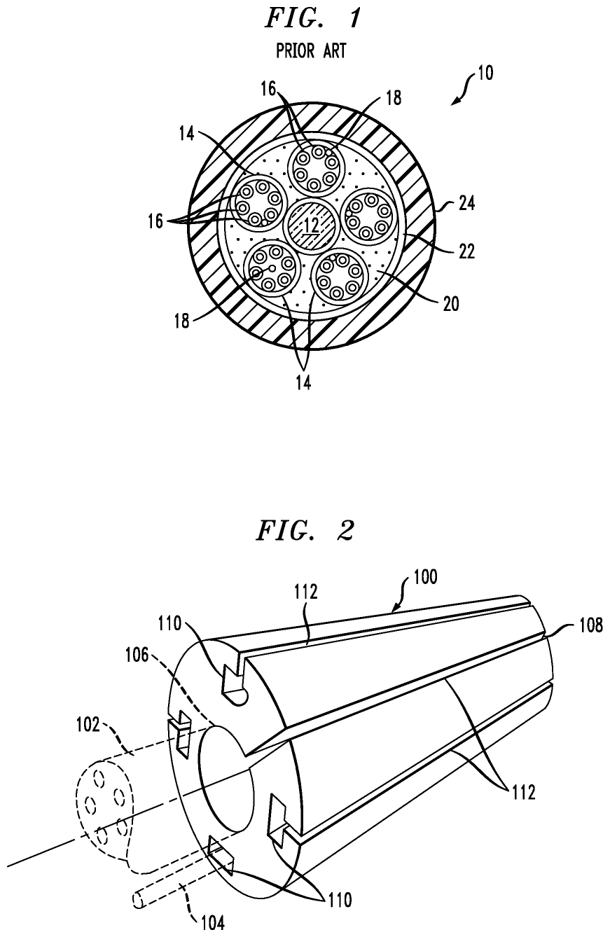

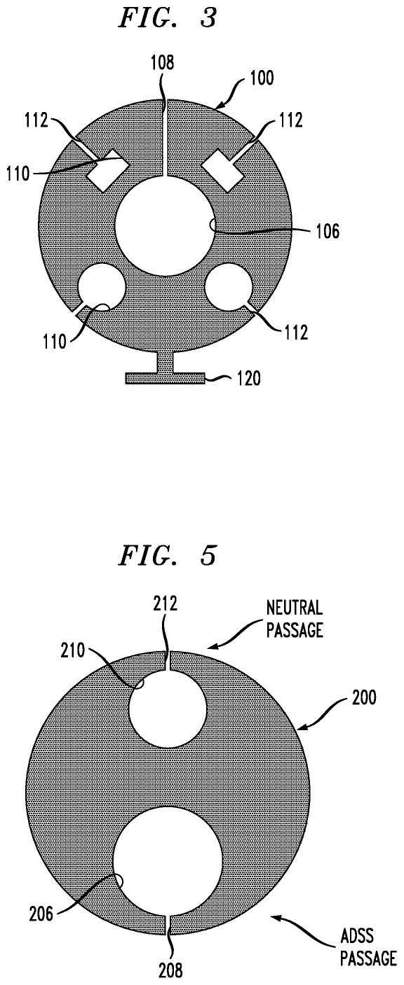

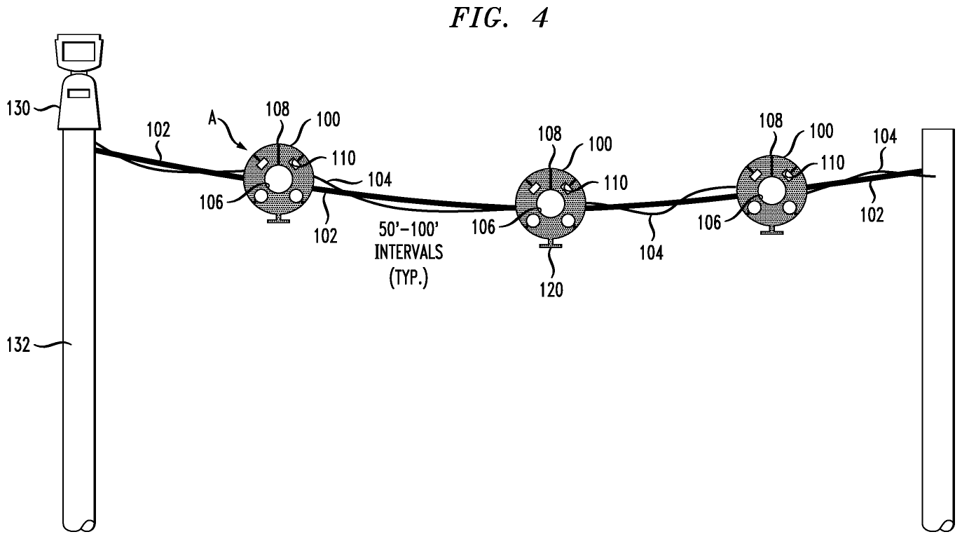

FIGS. 2 and 3 show two embodiments of a cable support member 100 according to the invention. When placed at determined intervals along a span of an ADSS trunk cable 102 (see FIG. 4), the members 100 enable a number of drop lines 104 together with associated cables or dielectric strands, to be supported by the cable 102 along the length of the span.

In the illustrated embodiments, the support member 100 is in the form of an elongated, non-metallic or dielectric cylinder. The member 100 can be made of, for example, ethylene propylene diene monomer (EPDM) rubber or equivalent resilient, weather resistant material. The member 100 has a main passage or opening 106 formed axially over the length of the member, and the passage 106 is sized to receive and contain a length of the trunk cable 104. The passage 106 has an associated first slit or slot 108 formed through the wall of the member 100 so that when the cable 102 is urged sideways through the slit 108 from outside the member, the cable can be received and contained in the main passage 106. The slit 108 may be cut along a straight line through the wall of the support member 100 as shown in FIG. 2, or along a wavy or curvilinear line so that once contained in the passage 106, additional force would be needed to displace the cable 104 back through the slit 108 and out of the support member 100.

In addition, the support member 100 has a number of outer passages 110 formed axially in the member 100 over the length of the member. Each outer passage 110 is sized to receive and contain one or more drop lines 102, and has an associated second slit or slot 112 formed through the wall of the member 100 so that when a given drop line 102 is urged sideways through the slit 112 from outside the member, the drop line can be received and contained in the corresponding outer passage 110. The passages 106, 110, and the slits 108, 112, may be formed, for example, while the support member 100 is being molded or extruded.

As shown in FIG. 2, all of the outer passages 110 in the support member 100 may be sized to accommodate flat drop lines 102, or, as shown in FIGS. 3 and 4, at least some of the outer passages 110 may be sized to contain round drop lines, dielectric strands, or metallic support wires, as needed. Typical dimensions (in mm) for the support member 100 are:
Length of support member 100: Approximately 150 mm
Outside Diameter of support member 100: Approximately 45 mm
Diameter of main passage 106: Sized to diameters of cables
Dimensions of flat outer passages 110: Sized to diameters of cables
Diameters of round outer passages 110: Sized to diameter of cables
Rubber durometer: 70, although other formulations may be used

The support member 100 may also have a generally T-shaped, thick rubber nub 120 that can be molded integrally with the member to project from the bottom of the member as viewed in FIG. 3. The nub 120 is dimensioned and formed to anchor, e.g., a UV protected EPDM rubber band after the band is firmly wound about the circumference of member 100 with the trunk cable 102 and the drop lines 104 contained in the member passages, thus helping to prevent the cable and the drop lines from becoming displaced from the passages through the associated slits 108, 112. The support member 100 may be formed without the nub 120, and provided with or without the securing band.

As shown in FIG. 4, the support members 100 may be placed at determined intervals of, e.g., 50 to 100 feet along a first span of the trunk cable 102. The drop lines 104 originate from a closure 134 that can be mounted on a pole 132 or other fixed structure at one end of the span. At the splice closure 134, a first set of fibers in the cable 102 are spliced or connected to corresponding fibers of the drop lines 104. The drop lines 104 may be wound about the trunk cable 102 or otherwise bound to the cable for support.

At a first location A along the first span, the trunk cable 102 is urged through the first slit 108 in the support member 100 and received in the main passage 106 in the member. Drop lines 104 that have been wound about the cable 102 and destined to users at or beyond the first location A, are urged through the second slits 112 and received in the outer passages 110 in the first support member 100. One or more of the drop lines 132 exiting the outer passages 110 in the first support member 100 and destined to designated users at the first location A, are then routed away from the cable 130 to the users.

The remaining drop lines 132 continue to be wound along the first span of the trunk cable 130 to a second location B, where one or more of the drop lines 132 are destined to users at the second location or beyond. The cable 130 is received in the main passage 106 of a second support member 100 at the second location B, and the drop lines 132 are received in corresponding outer passages 110 in the second support member. Those drop lines 132 exiting the outer passages 110 in the second support member 100 and destined to designated users at the second location B, are then routed away from the cable 130 to service the users. The remaining drop lines 132 continue to be wound along the span of the trunk cable 130 to a third location C where one or more of the drop lines 132 are destined to users at the third location C. The cable 130 is received in a third support member 100 at the third location C, and the remaining drop lines 132 are received in corresponding outer passages 110 in the third support member. The drop lines 132 exiting the outer passages 110 in the third support member 100 and destined to users at the third location C, are then routed away from the cable 130 to service the users.

Once all the drop lines 132 wound about the first span of the trunk cable 130 are routed to designated users located along the first span, a second set of fibers in the cable 130 are spliced or connected to corresponding fibers in a second set of drop lines 132 in a second splice closure 134 associated with a second span of the cable 130. As before, the second set of drop lines 132 are wound about or otherwise bound to the second cable span for support. The cable 130 and the drop lines 132 are received in the corresponding passages in one or more successive support members 100 at locations along the second span of the cable where the drop lines are destined to users located along the second span. At each location, one or m ore of the drop lines 132 exiting a support member 130 at the location and destined to users at the location, are routed away from the cable 130 to the users.

As disclosed herein, the inventive system including the support members 100 allow user drop lines to be supported by a span of a given ADSS trunk cable, and can also allow one or more additional ADSS cables to be supported along the given cable. Other advantages include:
1. The support members 100 allow the drop lines 132 to be deployed on an “as needed” basis.
2. The slit 112 in the support members 100 can be opened and closed repeatedly to allow additional drop lines 132 to be received in the outer passages 110 in the members and routed to new users, without interrupting service to existing users via the trunk cable 130.
3. Each support member 100 can be used with different numbers, sizes, and shapes of drop lines 132.
4. One of the outer passages 110 in the members 100 can be formed to receive and contain a separate dielectric strand to counter additional load tensions produced by the drop lines 132.
5. The support members 100 can be formed with passages to accommodate different numbers and shapes of drop lines or dielectric strands. Additional passages may also be formed to accommodate trunk cables having different outside diameters.
6. The support members 100 can be used with a dielectric strength member and a mid-span drop dead end to enable deployment of mid-span drops without an additional lashing wire. See, e.g., Preformed Line Products (PLP), Dead-end at the Structure, Premise or Backbone Cable Midspan, 2-page brochure (2009).

It will be understood that any published maximum rated cable load (MRCL) for a given ADSS trunk cable may need to be modified in view of added loading by the drop lines 132 through the support members 100, with the drops occurring either mid-span or at poles. Any such increased loading may be kept at a minimum by attaching drop lines only when a corresponding number of customers sign up, and only when additional drop lines are otherwise needed.

FIG. 5 is a cross-sectional profile of a third embodiment of a cable support member 200 according to the invention. The member 200 has a first or main passage 206 formed axially over the length of the member, and the passage 206 is sized to receive and contain a length of an ADSS trunk cable. The passage 206 has an associated first slit or slot 208 formed through the wall of the member 200 so that when the ADSS cable is urged sideways through the slit 208 from outside the member, the cable can be received and contained in the main passage 206.

In addition, the support member 200 has a second passage 210 formed axially over the length of the member. The second passage 210 is sized to receive and contain a non-metallic or metallic support cable such as an electrical neutral, and has an associated second slit or slot 212 formed through the wall of the member 200 so that when a support cable is urged sideways through the slit 212 from outside the member 200, the support cable can be received and contained in the second passage 210. The passages 206, 210, and the slits 208, 212, may be formed, for example, while the support member 200 is being molded or extruded.

While the foregoing represents preferred embodiments of the present invention, it will be understood by persons skilled in the art that various changes, modifications, and additions can be made without departing from the spirit and scope of the invention, and that the invention includes all such changes, modifications, and additions that are within the scope of the following claims.

1-22.

23. A system for supporting and routing drop lines from a trunk cable containing fibers for providing network service to designated users of the network, comprising:
a number of elongated, non-metallic cylindrical support members for supporting user drop lines along a span of a trunk cable, each member having a main passage over the length of the member, wherein the main passage is sized to receive and contain the trunk cable, and has an associated first slit along the length of the member which opens between the circumference of the member and the main passage when the cable is urged sideways through the first slit from outside the member to enter the main passage;
each support member has a number of outer passages over the length of the member, wherein each outer passage is sized to receive and contain one or more user drop lines and has an associated second slit along the length of the member which opens between the circumference of the member and the outer passage when a given drop line is urged sideways through the second slit from outside the member to enter the outer passage; and
wherein a given drop line exiting an outer passage of a given support member along the cable span is routed either through an outer passage in a successive support member along the cable span, or away from the trunk cable to service a designated user.

24. A system according to claim 23, including a closure fixed at one end of the cable span for connecting an end of each drop line to the cable.

25. A system according to claim 23, wherein the first and the second slits in each support member are formed with a wavy or curvilinear profile so that the cable and the drop lines received in the passages inside the member are restrained from escaping the member through the slits associated with the passages.

26. A system according to claim 23, wherein the support members are made of EPDM rubber.

27. A system according to claim 23, wherein at least one of the passages is formed to receive and contain a dielectric strength member to counter load tensions produced by the drop lines.

28. A system according to claim 23, wherein a number of the support members are placed along the span of the trunk cable at intervals of between approximately 50 and 100 feet (15.24 meters and 30.48 meters) apart from one another.

29. A support member for supporting drop lines from a trunk cable that provides network service to designated users of the network, comprising:
an elongated, non-metallic or dielectric cylinder having (a) a main passage formed axially over the length of the cylinder, wherein the main passage is sized to receive and contain a length of the trunk cable, and (b) a first slit formed through the wall of the cylinder, wherein the first slit opens between the circumference of the cylinder and the main passage so that when the trunk cable is urged sideways through the first slit from outside the cylinder, the cable can be received and contained in the main passage;
the cylinder has one or more outer passages formed axially over the length of the cylinder, wherein each outer passage is sized to receive and contain one or more user drop lines and has an associated second slit formed through the wall of the cylinder, wherein the second slit opens between the circumference of the cylinder and the outer passage so that when a given drop line is urged sideways through the second slit from outside the cylinder, the drop line can be received and contained in the outer passage,

30. A support member according to claim 29, wherein the cylinder is made of EPDM rubber.

31. A support member according to claim 29, wherein at least one of the outer passages is formed to receive and contain a dielectric strength member to counter load tensions produced by the drop lines.

32. A support member according to claim 29, wherein each of the first and the second slits in the cylinder are formed with a wavy or curvilinear profile so that the trunk cable and the drop lines received in the passages inside the cylinder, are restrained from escaping the passages through the associated slits.

33. A system according to claim 1, wherein the trunk cable is an all-dielectric self-supporting (ADSS) fiber optic cable.

34. A support member according to claim 29, wherein the trunk cable is an all-dielectric self-supporting (ADSS) fiber optic cable.
